(19) United States
(12) Patent Application Publication
(10) Pub. No.: US 2007/0216128 A1
(43) Pub. Date: Sep. 20, 2007

(54) Mounting Assembly for a Mud Flap and Method

(76) Inventor: Raymond Bruce Morton, Bonham, TX (US)

Correspondence Address: GRADY K. BERGEN, 3333 LEE PARKWAY, SUITE 600, DALLAS, TX, 75219, US

(21) Appl. No.: 11/678,139

(22) Filed: Feb. 23, 2007

Related U.S. Application Data
(60) Provisional application No. 60/775,878, filed on Feb. 23, 2006.

(51) Int. Cl. B62D 25/18

(52) U.S. Cl. 280/154

(57) ABSTRACT

A mounting assembly for a mud flap of a vehicle includes a mounting bracket for securing to a vehicle. A squeeze member having at least one aperture formed therein is provided with the mounting assembly. At least one wedge member having a wedge body with a transverse dimension that increases along the length of the wedge body is also provided. At least one wedge receiving member is coupled to the mounting bracket and projects through the at least one aperture of the squeeze member. The wedge receiving member has a wedge receiving portion configured for receiving the wedge body. The wedge body forces the squeeze member against the mounting bracket when the wedge body is received within the wedge receiving portion of the wedge receiving member so that the mud flap positioned between mounting bracket and squeeze member is frictionally held therebetween.

This application claims the benefit of U.S. Provisional Patent Application No. 60/775,878, filed Feb. 23, 2006, which is herein incorporated by reference in its entirety.

### BACKGROUND

The invention relates to wheeled vehicles, and more particularly, to mud flaps and devices for securing mud flaps to wheeled vehicles.

### BRIEF DESCRIPTION OF THE DRAWINGS

For a more complete understanding of the present invention, reference is now made to the following descriptions taken in conjunction with the accompanying figures, in which:

FIG. 1 is an exploded perspective view of a mounting assembly for a mud flap;

FIG. 2 is front elevational view of the mounting assembly of FIG. 1, shown with a mud flap held by the mounting assembly;

FIG. 3 is a top plan view of the mud flap assembly of FIG. 1;

FIG. 4 is side cross-sectional view of the mounting assembly of FIG. 3, taken along the lines IV-IV; and

FIG. 5 is an exploded perspective view of another embodiment mounting assembly for a mud flap;

FIG. 6 is a elevational view of still another embodiment of a mounting assembly for a mud flap mounted to a vehicle frame.

### DETAILED DESCRIPTION

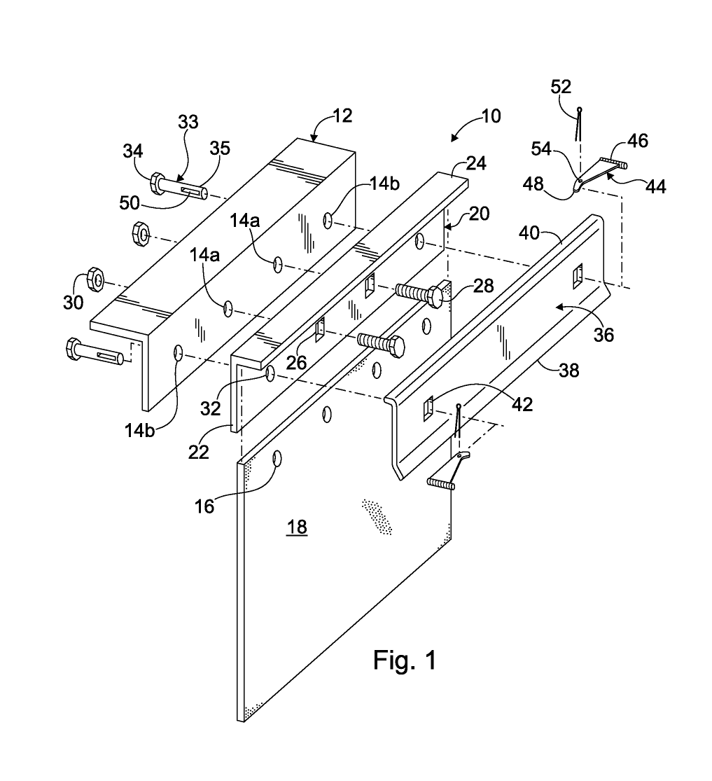

Referring to FIG. 1, a mounting assembly 10 for a mud flap is shown. The mounting assembly 10 may be employed with trucks, trailers and other wheeled vehicles. In particular, the mounting assembly 10 may be used on wheeled vehicles where the mud flaps are mounted at a location where they encounter objects during backing operations, which may result in the mud flap being pinched between the wheel and the object. In such instances, this can result in the mud flap being pulled or torn from the vehicle, resulting in damage to the mud flap and requiring substantial effort and costs in replacing the mud flap.

The assembly 10 may be configured for mounting to a preexisting mud flap bracket 12 or securing device that may be provided with the vehicle. Such conventional mud flap brackets 12 are typically mounted to the vehicle directly behind the rear wheels of the vehicle. The bracket 12 is typically provided with holes or apertures 14 that correspond to holes formed in a mud flap, such as the holes 16 of mud flap 18. Bolts are used to bolt the mud flaps 18 to the bracket 12. In the instances, as discussed above, where the mud flap is pinched during backing operations, the mud flap 18 may be pulled loose from the bracket 12, with the mud flap tearing or ripping from the holes 16, which are typically used in conventional mud flaps.

In the present invention, the mounting assembly 10 may be configured for retrofitting on existing vehicles by use with the preexisting bracket 12 or other mud flap securing device that may be provided with the vehicle. Alternatively, the mounting assembly 10 may be configured for installation during the original manufacture of the vehicle or without the need for the bracket 12. Additionally, the mounting assembly may be coupled to the vehicle by other means, such as by welding, bolting, etc.

The mounting assembly 10 includes an elongated mounting bracket 20, which may have a generally L-shaped cross section, as shown in FIG. 1, with mounting bracket angled plate members 22, 24 being generally at right angles to one another. The plate member 22 may be configured for generally abutting against the bracket 12. In the embodiment shown, the plate member has a height of about 3 inches. Mounting holes 26 may be provided in the plate 22 and may be located and configured for corresponding to the two center holes 14A of the mud flap bracket 12. The holes 26 may be slightly oversized or elongated to facilitate variances in the position of the holes 14A of the bracket 12. Bolts 28 and nuts 30 may be used to couple the mounting bracket 20 to the mud flap bracket 12.

A pair of apertures or holes 32 is also provided in the plate member 22 of mounting bracket 20. The holes 32 are located and configured to correspond to the two outermost holes 14B of the mud flap bracket 12. The holes 14B, 32 receive a pair of wedge bolts 33. The wedge bolts 33 are provided with a head 34 at one end and a shank 35, which extends from the head 34.

The mounting assembly 10 also includes a squeeze plate 36. The squeeze plate 36 may have a generally flat body but may be outwardly flared or curved at the lower end 38, as is shown. A lip or inwardly projecting rim 40 is provided at the upper end of squeeze plate 36. Apertures or holes 42 are provided in the plate 36 and are positioned to generally correspond to the apertures 32 of mounting plate 20. The apertures 42 may be oversized or slightly elongated to facilitate aligning of the holes 42 with the holes 32 of mounting plate 20. The position of the apertures 32 and holes 42 may vary, but a suitable location is from about 1 to 2 inches or more below the plate 24, when assembled.

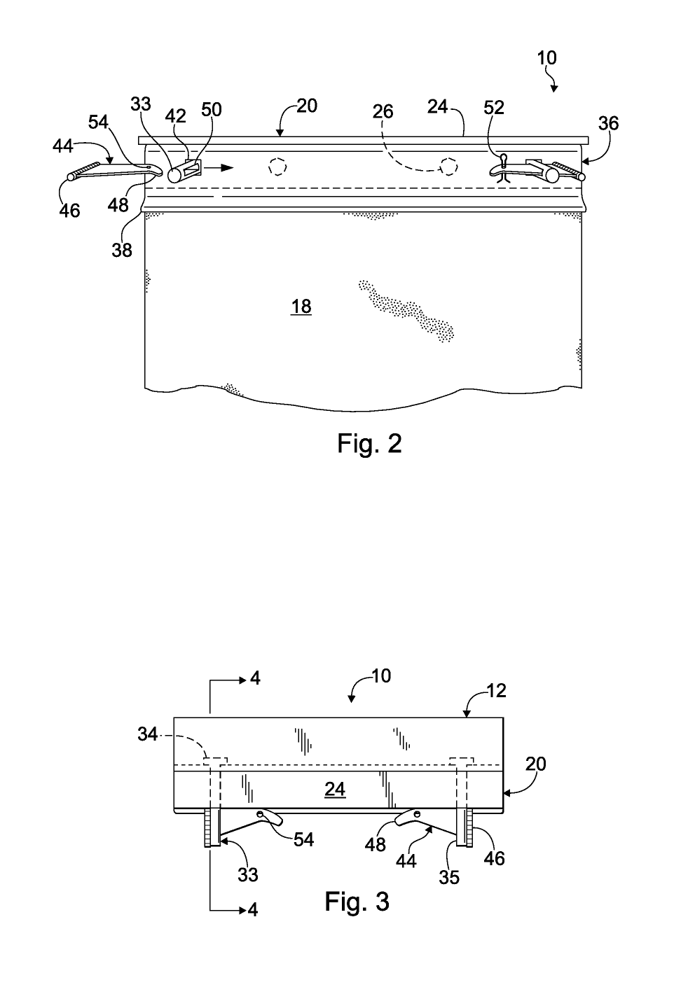

The mounting assembly 10 is provided with a pair of wedge members 44. The wedge members 44 may have a body with a generally curved configuration, as shown. The body of the wedge member 44 tapers inwardly in width from a head 46 at one of the wedge member 44 to a tip 48. The body of the wedge members 44 may be generally flat or have a generally uniform thickness, which corresponds to an elongated slot 50 formed in the shank 35 of the wedge bolt 33 (FIG. 2). The head 46 is sized to prevent passage of the wedge member 44 through the slot 50 of the wedge bolt 33. A cotter pin or wedge retaining member 52 may be provided with the wedge member 44 and is received within hole 54 formed in the wedge body at a position opposite the head 46.

In use of the mounting assembly 10, if not already installed, the mounting plate 20 may be bolted or otherwise coupled to an existing mud flap bracket 12 or mud flap securing device by means of the bolts 28 and nuts 30. Alternatively, the mounting plate 20 may be coupled to the frame of the vehicle through other means. The wedge bolts 33 are also inserted through holes 14B, 32 and also facilitate mounting of the mounting plate 20 to the mud flap bracket 12.

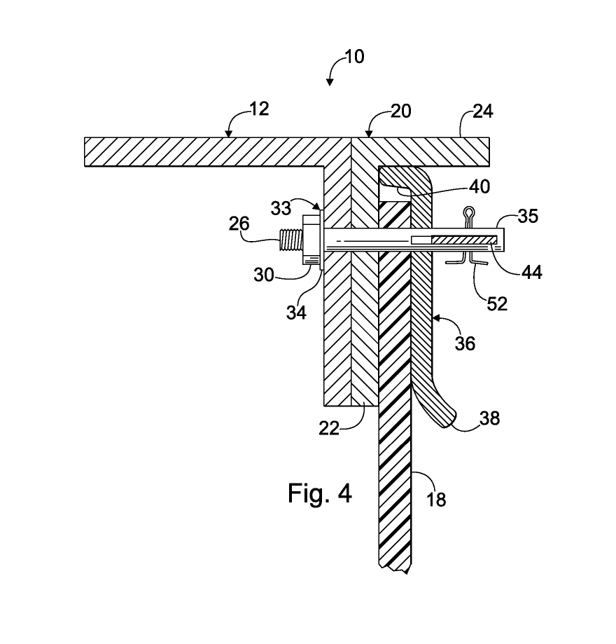

The squeeze plate 36 is positioned against the mounting plate 20 with the lip 40 underlying the plate member 24, as is shown in FIG. 3, with the wedge bolts 33 passing through the apertures 42. The mud flap 18 is positioned between the mounting plate 20 and squeeze plate 36, as shown in FIG. 4. Although the mud flap 18 is shown in FIG. 1 as having holes for conventional mounting to the mud flap bracket 12, these may be eliminated from the mud flap 18 since the holes 16 are not used for securing of the mud flap.

With the mud flap 18 positioned between the plates 20, 36, the wedge members 44, if not already inserted, are inserted into the slots 50 of wedge bolts 33. As shown in FIG. 4, the slot 50 is located and has a sufficient length such that extends across at least a portion of the thickness of the squeeze plate 36 when the mud flap 18 is inserted between plates 20, 36. In this way, the wedge members 44 force the squeeze plate 36 towards the mounting plate 20 and against the mud flap 18 as they are inserted through the slots 50 of the wedge bolts 33. A hammer or other tool may be used to securely seat the wedge members 44 within the slots 50. This securely fixes the mud flap 18 in place between the plates 20, 36. The cotter pin or retaining member 52 may then be positioned within the aperture 54 of the wedge member 44. The cotter pin 52 prevents loss of the wedge members 44 during use, should the wedge members 44 become loose.

The mounting assembly 10 securely holds the mud flap 18 in place upon the vehicle without falling. If the mud flap 18 is pulled loose from the mounting assembly 10, however, such as during backing operations where the mud flap becomes pinched between the tire and another object, there is no damage to the mud flap, as would occur in conventional mounting methods where the mud flap is ripped loose from the mounting bolts. Further, the above-described mounting method allows such damaged or ripped mud flaps to be reused without cutting the mud flap and/or punching new holes in the mud flap.

If the mud flap falls from the mounting assembly 10, it is merely repositioned between the plate members 20, 36. The wedge members 44 may then be reseated and secured within the slots 50 of the wedge bolts 33, as previously described.

In an alternate embodiment, the bolts 28 and nuts 30 that are used to secure the mounting plate 24 to the mud flap bracket 12 may be eliminated and the wedge bolts 33 may be passed through the holes 14B of the mud flap bracket 12 and through the holes 32. In this way, the wedge bolts 33 secure the mounting assembly 10 to the bracket 12. Additional wedge bolts 33 may be used with additional wedge members 44, with the wedge bolts 33 passing through apertures 14A, 26 in the mounting plate 24 and apertures (not shown), which may be formed in the squeeze plate 36, to provide a stronger coupling. Additionally, the position of the apertures 32 and holes 42 may be inverted, with the mounting holes 26 being located at the ends and the apertures 32 being located in the middle. In such instances, the holes 42 in squeeze plate 36 would also be positioned toward the center to align with the apertures 32.

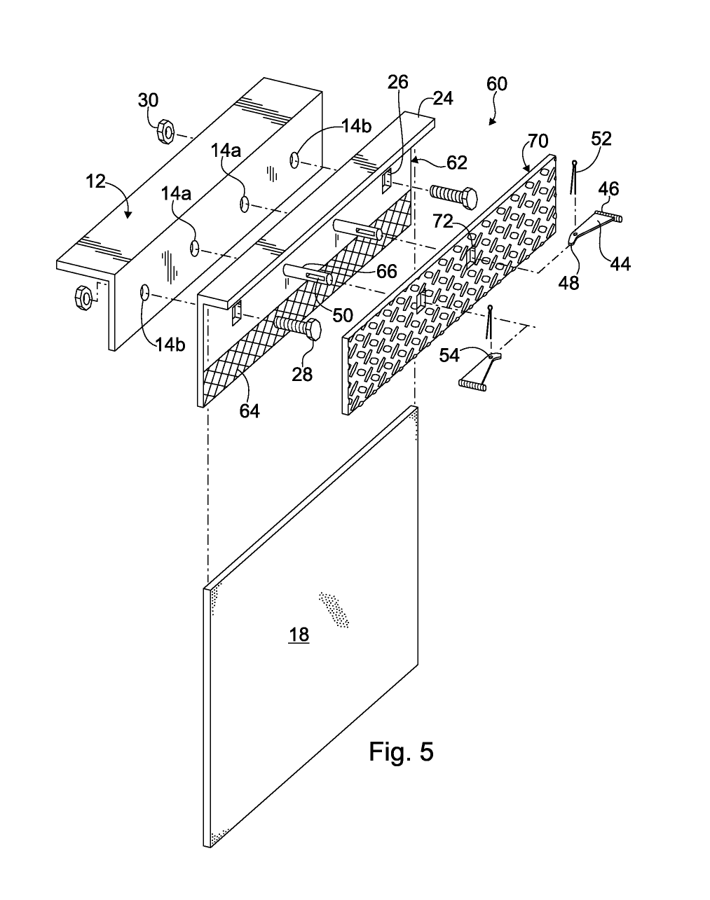

FIG. 5 shows another embodiment of a mud flap mounting assembly 60. The mounting assembly 60 is similar in construction to the mounting assembly 10, previously described, with similar components labeled with the same reference numeral. The assembly 60 includes a mounting plate 62 that is similar to the mounting plate 20. The mounting plate 62 also includes vertical plate member 64 and horizontal plate member 24. In the embodiment shown, the plate member 64 has a height of about 4½ to 5 inches.

In the embodiment shown, instead of separate wedge bolt members that project through the plate member 64, wedge bolt members 66 are joined directly to the plate member 64, such as by welding, casting, threading or the like, with and project from plate 64. The wedge bolt members 66 are positioned inwardly from the ends of the plate member 64, with the mounting holes 26 being located near the ends of the plate member 64. Although the position of the bolt members may vary, as an example, the wedge bolt members 66 may be located about 1½ inches below the plate member 24 and spaced about 5 to 7 inches from each end of the plate member 64.

A squeeze plate 70 is provided with the assembly 60. The squeeze plate 70 is similar to the squeeze plate 36, but is formed as a generally flat plate, with no projecting lip or flared lower end. In the embodiment shown, the squeeze plate 70 is formed from a piece of diamond metal plate, so that it is provided with texturized surfaces. Apertures 72 are provided in the plate 70 for receiving the wedge bolt members 66.

One or both of the plate member 64 and squeeze plate 70 may be provided with a textured surface. In the embodiment shown, the plate member 64 is provided with a layer or strip of expanded metal (e.g. ⅛ inch thick), which may be welded or otherwise coupled to the plate member 64, to provide a textured surface.

In use of the mounting assembly 60, if not already installed, the mounting plate 62 may be bolted or otherwise coupled to an existing mud flap bracket 12 or mud flap securing device by means of the bolts 28 and nuts 30.

The squeeze plate 70 is positioned against the mounting plate 62 with the upper end of the plate 70 underlying the plate member 24. The wedge bolt members 66 are passed through the apertures 72. The mud flap 18 is positioned between the mounting plate 62 and squeeze plate 70. The mud flap 18 is shown in FIG. 5 as having no row of holes, as would a conventional mud flap, since no holes are necessary for mounting.

With the mud flap 18 positioned between the plates 64, 70, the wedge members 44, if not already inserted, are inserted into the slots 50 of wedge bolt members 66. As shown in FIG. 5, the slot 50 is located and has a sufficient length such that extends across at least a portion of the thickness of the squeeze plate 70 when the mud flap 18 is inserted between plates 64, 70. In this way, the wedge members 44 force the squeeze plate 70 towards the mounting plate 62 and against the mud flap 18 as they are inserted through the slots 50 of the wedge bolt members 66. A hammer or other tool may be used to securely seat the wedge members 44 within the slots 50 by hitting the head 46 of the members 44. This securely fixes or pinches the mud flap 18 in place between the plates 64, 70. The cotter pin or retaining member 52 may then be positioned within the aperture 54 of the wedge member 44. The cotter pin 52 prevents loss of the wedge members 44 during use, should the wedge members 44 become loose.

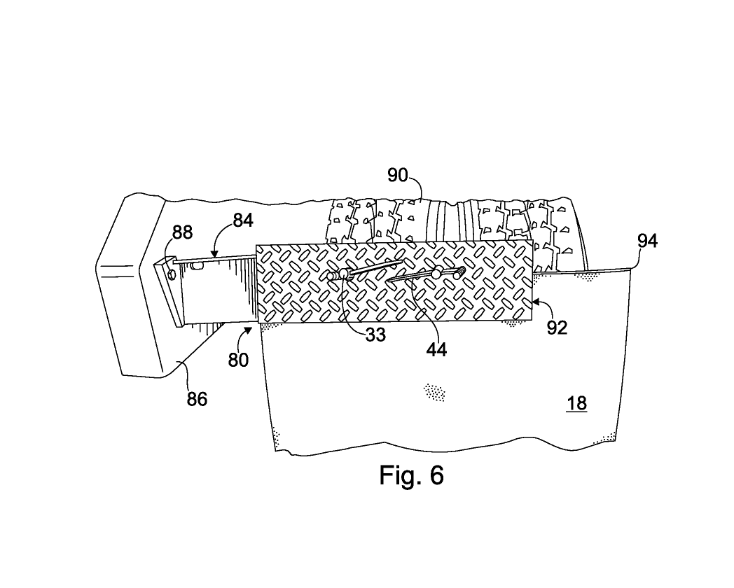

Referring to FIG. 6, another embodiment of a mud flap mounting assembly 80, such as may be used with semi-tractor vehicles, and the like. The assembly 80 is similar in construction to the mud flap mounting assemblies 10, 60, previously described. In the embodiment shown, the mounting assembly 80 does not employ an existing mounting bracket used for mud flaps, but is mounted directly to the vehicle frame through a mounting member 82. The mounting member 82 is coupled, such as by welding and the like, to one end of the mounting plate 84, which may be similar in construction to the mounting plates 20, 62, previously described. The mounting plate 82 is coupled, such as through bolt 88, welding or other fastening means, to the vehicle frame 86 adjacent to the vehicle wheels 90, which may or may not be exposed. In this way the mounting plate 84 is cantilevered outward from the frame 86 so that the free end is positioned rearwardly adjacent to the wheels 90.

A squeeze plate 92 is provided with the mounting assembly 80, which is similar in construction to the squeeze plates 36, 70, previously described. In the embodiment shown, the squeeze plate is shorter in length so that it only coextends along the outermost portion of the mounting plate 84, opposite the frame 86, as is shown.

A mud flap 18 is positioned between the mounting plate 84 and squeeze plate 92 in a similar manner with respect to the embodiments 10 and 60, previously described, with the use of wedge members 44 and bolt members 33.

As shown in FIG. 6, the corner 94 of the mud flap 18 extends laterally outward from the mounting assembly 80 several inches. Thus, objects that impact the outer edge of the mud flap 18 will merely deflect the mud flap and will be less likely to pull it loose from the mounting assembly 80. This also facilitates the mounting assembly 80 from becoming damaged from such impacts.

While the invention has been shown in only some of its forms, it should be apparent to those skilled in the art that it is not so limited, but is susceptible to various changes and modifications without departing from the scope of the invention.

1. A mounting assembly for a mud flap of a vehicle comprising:
a mounting bracket for securing to a vehicle;
a squeeze member having at least one aperture formed therein;
at least one wedge member having a wedge body with a transverse dimension that increases along the length of the wedge body; and
at least one wedge receiving member that is coupled to the mounting bracket and projects through the at least one aperture of the squeeze member, the wedge receiving member having a wedge receiving portion configured for receiving the wedge body; and wherein
the wedge body forces the squeeze member against the mounting bracket when the wedge body is received within the wedge receiving portion of the wedge receiving member so that the mud flap positioned between mounting bracket and squeeze member is frictionally held therebetween.

2. The mounting assembly of claim 1, wherein:
there are two wedge members and two wedge receiving members.

3. The mounting assembly of claim 1, wherein:
the mounting bracket includes a mounting plate that abuts against a surface of the mud flap; and
the squeeze member includes a squeeze plate that abuts against an opposite surface of the mud plate.

4. The mounting assembly of claim 3, wherein:
at least one of the mounting plate and squeeze plate is texturized to facilitate holding of the mud flap therebetween.

5. The mounting assembly of claim 1, further comprising:
a wedge retainer for retaining the wedge body within the wedge receiving portion.

6. The mounting assembly 1, wherein:
the mounting assembly is configured so that only a portion of the width of the mud flap is held by the mounting assembly, with a side portion of the mud flap projecting beyond the mounting assembly.

7. A mud flap assembly for a vehicle comprising:
a mounting bracket for securing to a vehicle;
a mud flap;
a squeeze member having at least one aperture formed therein;
at least one wedge member having a wedge body with a transverse dimension that increases along the length of the wedge body; and
at least one wedge receiving member that is coupled to the mounting bracket and projects through the at least one aperture of the squeeze member, the wedge receiving member having a wedge receiving portion configured for receiving the wedge body; and wherein
the wedge body forces the squeeze member against the mounting bracket when the wedge body is received within the wedge receiving portion of the wedge receiving member so that the mud flap positioned between mounting bracket and squeeze member is frictionally held therebetween.

8. The mud flap assembly of claim 7, wherein:
there are two wedge members and two wedge receiving members.

9. The mud flap assembly of claim 7, wherein:
the mounting bracket includes a mounting plate that abuts against a surface of the mud flap; and
the squeeze member includes a squeeze plate that abuts against an opposite surface of the mud plate.

10. The mud flap assembly of claim 9, wherein:
at least one of the mounting plate and squeeze plate is texturized to facilitate holding of the mud flap therebetween.

11. The mud flap assembly of claim 7, further comprising:
a wedge retainer for retaining the wedge body within the wedge receiving portion.

12. The mud flap assembly 7, wherein:
only a portion of the width of the mud flap is held between the mounting bracket and squeeze member, with a side portion of the mud flap projecting therefrom.

13. A method of mounting a mud flap to a vehicle comprising:
providing a mounting assembly that mounts to the vehicle, the mounting assembly comprising:
a mounting bracket for securing to a vehicle;
a squeeze member having at least one aperture formed therein;
at least one wedge member having a wedge body with a transverse dimension that increases along the length of the wedge body; and
at least one wedge receiving member that is coupled to the mounting bracket and projects through the at least one aperture of the squeeze member, the wedge receiving member having a wedge receiving portion configured for receiving the wedge body; and
positioning a portion of the mud flap between the mounting bracket and the squeeze member;
inserting the wedge body into the wedge receiving portion so that the wedge body forces the squeeze member against the mounting bracket so that the mud flap positioned between mounting bracket and squeeze member is frictionally held therebetween.
